(19) United States
(12) Patent Application Publication
(10) Pub. No.: US 2011/0269889 A1
(43) Pub. Date: Nov. 3, 2011

(54) Treads, inner liners and inner tubes for vehicle tyres, and compositions therefor

(76) Inventor: Godfrey Stewart Short, Cirencester (GB)

(21) Appl. No.: 12/771,708

(22) Filed: Apr. 30, 2010

(51) Int. Cl. C08K 3/34

(52) U.S. Cl. 524/444

(57) ABSTRACT

A composition for a tread, inner liner or inner tube for a vehicle tyre includes a natural or synthetic rubber binder and a filler, the filler including alumino silicate microspheres formed from pulverised fly ash. The microspheres are inexpensive, are produced from ash which would otherwise be discarded to landfill and unexpectedly provide good wet grip, low rolling resistance and/or high impermeability to air in the end product.

### BACKGROUND OF THE INVENTION

1. Field of the Invention

This invention relates to vehicle tyres, and in particular to treads, inner liners and inner tubes for vehicle tyres and to compositions for forming such treads, liners and tubes.

2. Description of the Related Art

Compositions used in the manufacture of vehicle tyres and inner tubes conventionally include a binder and a filler. The filler serves not only to reduce the amount and cost of binder that is required but also to improve the performance of the end product, or at least the filler should not degrade the performance of the end product.

Two important measures of performance of a vehicle tyre tread are its ability to grip to the road surface in the wet and its rolling resistance. Low wet grip performance can lead to skidding and accidents. High rolling resistance results in excess fuel consumption and overheating of the tyre. An important measure of performance of an inner liner of a tyre and of a tyre inner tube is obviously its impermeability to air. It is well known that the choice of filler for the tread material can significantly affect these measures of performance. A desirable quality of any filler material is that it should be inexpensive and not use the planet's resources needlessly.

Pulverised fly ash is produced from the combustion of coal in electricity generating power stations. It is collected from the exhaust gas stream of the furnace either in electrostatic precipitators or sometimes in a filter. It is estimated that in excess of 500 million tonnes of fly ash was produced globally during 2005. Traditionally, the ash was disposed of in landfill. However, rather than doing that, techniques have been developed for processing the fly ash economically, as described, for example, in patent documents GB2320245A, U.S. Pat. No. 6,269,952B and EP0948410B to produce useful products such as cement constituents, carbon for fuel use, carbon for use in industrial processes, magnetite, and solid or hollow microspheres of alumino silicate glass. These microspheres find uses, for example, as fillers in plastics and paints and have several advantages. They have a lower cost and lower density than many other fillers. They produce a higher wear resistance than other fillers. They readily disperse uniformly throughout the filled material. Also, when used as a filler in moulded plastics, the microspheres produce a lower melt viscosity of the molten filled plastic than many other fillers, due to their spherical shape, enabling thinner wall thicknesses to be moulded. These microspheres therefore provide excellent functionality as fillers.

### BRIEF SUMMARY OF THE INVENTION

An aim of the present invention or at least of specific examples of it, is to provide a composition for a tread, inner liner or inner tube for a tyre employing a filler material which is inexpensive and which otherwise might be discarded and which provides good wet grip, low rolling resistance and/or high impermeability to air in the end product.

In accordance with a first aspect of the present invention, there is provided a composition for a tread, inner liner or inner tube for a vehicle tyre, the composition including a natural or synthetic rubber binder and a filler, the filler including alumino silicate microspheres formed from pulverised fly ash.

As will be described in detail below, it has now been found that such alumino silicate microspheres can provide unexpected advantages with regard to wet grip, rolling resistance and air impermeability when used as a filler in treads, inner liners or inner tubes for a vehicle tyres.

The alumino silicate microspheres used in the filler preferably have a median diameter at least 1 micron and more preferably of at least 4 microns. Their median diameter is preferably no more than 50 microns, and more preferably no more than 20 microns.

Benefits can be obtained when the alumino silicate microspheres constitute at least 8% by weight of the total filler and more particularly when they constitute at least 16% by weight of the total filler. In some applications of the invention, the alumino silicate microspheres constitute at least 30% by weight of the total filler. The remaining filler may be provided by conventional filler materials such as silica and/or carbon black.

The binder of the composition may include conventional materials such as styrene butadiene and/or polybutadiene particularly when the composition is to be used in the manufacture of a tyre tread, or isobutylene particularly when the composition is to be used in the manufacture of a tyre inner lining or an inner tube for a tyre.

Other aspects of the invention relate to a vehicle tyre having a tread formed from a composition according to the first aspect of the invention, a vehicle tyre having an inner liner formed from a composition as claimed in any preceding claim according to the first aspect of the invention, and an inner tube for a vehicle tyre formed from a composition according to the first aspect of the invention.

### BRIEF DESCRIPTION OF THE SEVERAL VIEWS OF THE DRAWINGS

FIGS. 1 to 3 of the drawings are graphs illustrating results on tests of a conventional example and examples of the invention

### DETAILED DESCRIPTION OF THE INVENTION

The components of the tyre tread compositions of a conventional example and Examples 1 and 2 of the invention are set out in Table 1 below.

TABLE 1
Tread compositions of Conventional example and Examples 1 and 2

| Conven- | Example | Example |
|---|---|---|
| tional | 1 | 2 |

| | | | |
|---|---|---|---|
| Component | Proprietary name | SG | Weight (% weight) |

Binders

| | | | | | |
|---|---|---|---|---|---|
| Oil extended solution styrene | Buna VSL 5525-1 | 0.96 | 103.1 | 103.1 | 103.1 |
| butadiene rubber (SBR) | | | (43.3%) | (42.4%) | (41.6%) |
| Neodymium catalysed | High CIS BR | 0.91 | 25.0 | 25.0 | 25.0 |
| polybutadiene (BR) | | | (10.5%) | (10.3%) | (10.1%) |

Fillers

| | | | | | |
|---|---|---|---|---|---|
| Precipitated silica | Ultrasil VN3 | 2 | 80.0 | 75.0 | 70.0 |
| | | | (33.6%) | (30.9%) | (28.2%) |
| Alumino silicate microspheres | Rocktron Mintron 7 | 2.2 | 0.0 | 10.0 | 20.0 |
| from pulverised fly ash. 7 μm | | | (0%) | (4.1%) | (8.1%) |
| Carbon black - Si69 silane blend - | Degussa X 50-S | 1.344 | 12.8 | 12.8 | 12.8 |
| 50% | | | (5.4%) | (5.3%) | (5.2%) |

Other

| | | | | | |
|---|---|---|---|---|---|
| Aromatic process oil | Alcanplast A741 | 1 | 5.0 | 5.0 | 5.0 |
| | | | (2.1%) | (2.1%) | (2%) |
| Zinc oxide | Alchem low lead/ | 5.6 | 2.5 | 2.5 | 2.5 |
| | pharma | | (1.1%) | (1%) | (1%) |
| Vegetable derived stearic acid | Stearic acid 1890 | 0.85 | 1.0 | 1.0 | 1.0 |
| | | | (0.4%) | (0.4%) | (0.4%) |
| N-(1,3-dimethylbutyl)-N′-phenyl- | Vulkanox 4020/LG | 0.995 | 2.0 | 2.0 | 2.0 |
| p-phenylenediamine (6PPD) | | | (0.8%) | (0.8%) | (0.8%) |
| Anti-ozone protective wax | Okerin 1900H | 0.91 | 1.5 | 1.5 | 1.5 |
| | | | (0.6%) | (0.6%) | (0.6%) |
| N-cyclohexyl-2- | Vulkacit CZ/EG-C | 1.28 | 1.7 | 1.7 | 1.7 |
| benzothiazolesulfenamide (CBS) | | | (0.7%) | (0.7%) | (0.7%) |
| 1,3-diphenylguanidine (DPG) | Vulkacit D/EG-C | 1.19 | 2.0 | 2.0 | 2.0 |
| | | | (0.8%) | (0.8%) | (0.8%) |
| Oil damped soluble sulphur | 300 mesh sulphur | 2.04 | 1.4 | 1.4 | 1.4 |
| | & mineral oil | | (0.6%) | (0.6%) | (0.6%) |
| | | Total | 238 | 243 | 248 |
| | | | (100%) | (100%) | (100%) |

The composition of the Conventional Example is based on the teachings of patent document U.S. Pat. No. 5,227,425 (Michelin), the content of which is incorporated herein by reference.

It will be noted that the components of all three examples are identical except that, by comparison with the Conventional Example, in Examples 1 and 2 a quantity of the precipitated silica has been omitted and replaced with twice the phr quantity of Rocktron Mintron 7 alumino silicate microspheres formed from pulverised fly ash and having a median particle size of 7 microns and available from Rocktron of Bristol, BS31 1TP, United Kingdom. The omitted precipitated silica was replaced with twice the PHR quantity of alumino silicate microspheres in order to attempt to maintain key physical properties of the end product such as modulus.

It will also be noted that, in Example 1 of the invention, the alumino silicate microspheres constitute 10.2% by weight of the total filler and that in Example 2 of the invention, the alumino silicate microspheres constitute 19.5% by weight of the total filler.

The formulations were mixed in a two-stage mixing process with a laboratory scale tangential mixing machine.

The first mixing stage was dedicated to the ‘silanisation’ coupling reaction between the Si69 silane [(Bis(triethoxysilylpropyl)tetrasulfane] component of Degussa X 50-S and the silica surface. In theory the coupling reaction should also be able to take place between the alumino silicate microspheres and silane, as silanol groups should also be present on the surface of these filler particles too. A master batch mixing cycle was designed to try and ensure that the compound sees a minimum of 5 minutes at temperatures in between the range of 145 to 155° C. Degussa-Evonik recommend the compound is exposed to this temperature range for a time between 5 and 10 minutes. It is important the 155° C. limit is not exceeded for any length of time as this can bring about premature scorching of the compound.

The mixing sequence of the first masterbatch reactive mixing stage employed a Banbury temperature of 85° C., an initial rotor speed of 72 rpm and comprised the following steps: (i) at start time, add SBR followed by BR and lower ram; (ii) at 0.5 minutes from start, raise ram, add one half of the precipitated silica, alumino silicate microspheres (where present), carbon black silane blend and process oil, and lower ram; (iii) at 1.5 minutes, raise ram, add other half of mixture, and lower ram; (iv) at 3 minutes, raise and lower ram; (v) at 4.5 minutes, raise and lower ram; (vi) at 5 minutes, open door to facilitate removal of volatile ethanol condensation product; (vii) at 6 minutes, reduce speed to 60 rpm; (viii) at 7 minutes, raise and lower ram; (ix) at 8 minutes, raise and lower ram; (x) at 9 minutes, raise and lower ram; and (xi) at 10 minutes, dump.

After a rest period of 16 hours, the masterbatch compounds were converted by the second mixing stage in which the curatives were added. The second mixing stage employed a Banbury temperature of 30° C., an initial rotor speed of 60 rpm and comprised the following steps: (i) at start time, add two-thirds of the masterbatch and lower ram; (ii) at 0.5 minutes from start, raise ram, add curatives (i.e. the remaining components listed in the table above) followed by the remaining masterbatch and lower ram; (iii) at 2 minutes, raise ram, brush down and lower ram; (iv) at 3 minutes, raise and lower ram; and (v) at 4.5 minutes, dump.

Specimens were then compression moulded from the compositions at 160° C. Also, each compound was tested on a dynamic mechanical analysis (DMA) machine with both strain sweeps and temperature sweeps. In the case of strain sweeps, the chosen temperature was 70° C., and the double strain amplitude (DSA) was varied between 0.04% and just above 2.0% with an autotension factor of 1.75 and the results being the mean of seven sweeps. In the case of temperature sweeps, the chosen DSA was 0.14% and the temperature was varied between −80° C. and +80° C. at a rate of 4° C. per minute. In both cases, the tests were carried out in tensile mode with an operating frequency of 10 Hz.

In a DMA test, “Delta” is the phase angle with which the strain lags behind the stress in a dynamic cycle. “Tan Delta” is a useful measure of energy loss of a compound and can be expressed as the ratio of the viscous component E″ of modulus to the elastic component E′ of modulus, i.e. Tan Delta=E″/E′.

Tan Delta at a temperature in the region of 0° C. is commonly used as a predictor of tyre wet grip performance; the higher Tan Delta, the better the wet grip performance. (See: “Improved tire wet traction through the use of mineral fillers”, Mouri et al, Bridgestone Corporation, Japan, Rubber Chemistry and Technology, Vol. 72, 1999, Pages 960-968; and “Viscoelastic properties of elastomers and tire wet skid resistance”, Takino et al, Toyo Tire and rubber Co. Ltd, Japan, Rubber Chemistry and Technology, Vol. 70, 1997, Pages 584-594.) On the other hand, Tan Delta at temperatures in the region of 60 to 70° C. (tyre tread operating temperature region) is widely used as a predictor of tyre rolling resistance; the higher Tan Delta, the greater the rolling resistance.

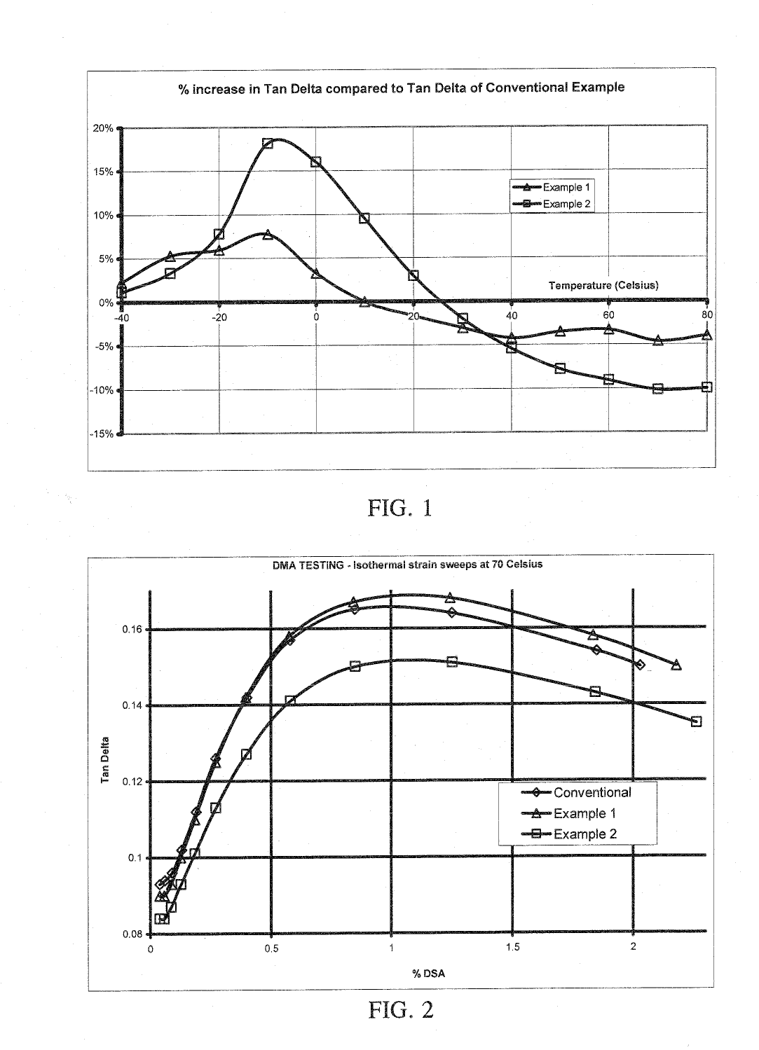

The results of the DMA temperature sweep test in the range −40° C. to +80° C. are set out in Table 2 below. Also, for each of the Examples of the invention and for each temperature, the percentage increase in Tan Delta for the Example of the invention compared with Tan Delta for the Conventional Example is set out in Table 2 and shown in FIG. 1 of the drawings.

TABLE 2
DMA Temperature sweep at DSA 0.14%

| | | | | (Tan Delta − Conventional | |
|---|---|---|---|---|---|
| | | | | Tan Delta)/Conventional | |
| | Tan Delta | | | Tan Delta | |
| Tem- | Conven- | Example | Example | Example | Example |
| perature | tional | 1 | 2 | 1 | 2 |
| −40 | 0.088 | 0.090 | 0.089 | 2.3% | 1.1% |
| −30 | 0.151 | 0.159 | 0.156 | 5.3% | 3.3% |
| −20 | 0.269 | 0.285 | 0.290 | 5.9% | 7.8% |
| −10 | 0.413 | 0.445 | 0.488 | 7.7% | 18.2% |
| 0 | 0.394 | 0.407 | 0.457 | 3.3% | 16.0% |
| 10 | 0.305 | 0.305 | 0.334 | 0.0% | 9.5% |
| 20 | 0.239 | 0.235 | 0.246 | 4.7% | 2.9% |
| 30 | 0.196 | 0.190 | 0.192 | −3.1% | −2.0% |
| 40 | 0.166 | 0.159 | 0.157 | −4.2% | −5.4% |
| 50 | 0.141 | 0.136 | 0.130 | −3.5% | −7.8% |
| 60 | 0.121 | 0.117 | 0.110 | −3.3% | −9.1% |
| 70 | 0.108 | 0.103 | 0.097 | −4.6% | −10.2% |
| 80 | 0.100 | 0.096 | 0.090 | −4.0% | −10.0% |

As can be seen, for Example 1 of the invention at 70° C., Tan Delta is 4.6% less than for the Conventional Example and, for Example 2 of the invention, Tan Delta is 10.2% less, suggesting that the rolling resistance of tyre treads made from the compounds of Examples 1 and 2 of the invention will, at high-speed operating temperatures, be significantly less than the rolling resistance of tyre treads made from the compound of the Conventional Example.

Also, for Example 1 of the invention at 0° C., Tan Delta is 3.3% more than for the Conventional Example and, for Example 2 of the invention, Tan Delta is 16% more, suggesting that the wet grip performance of tyre treads made from the compounds of Examples 1 and 2 of the invention will be significantly better than the wet grip performance of tyre treads made from the compound of the Conventional Example.

The results of the DMA strain sweep test at 70° C. are set out in Table 3 below and shown in FIG. 2 of the drawings.

TABLE 3
DMA Strain sweep at 70 Celsius

| Conventional | | Example 1 | | Example 2 | |
|---|---|---|---|---|---|
| DSA (%) | Tan Delta | DSA (%) | Tan Delta | DSA (%) | Tan Delta |
| 0.04 | 0.093 | 0.04 | 0.09 | 0.04 | 0.084 |
| 0.06 | 0.094 | 0.058 | 0.09 | 0.058 | 0.084 |
| 0.09 | 0.096 | 0.087 | 0.093 | 0.087 | 0.087 |
| 0.13 | 0.102 | 0.126 | 0.100 | 0.127 | 0.093 |
| 0.19 | 0.112 | 0.185 | 0.110 | 0.185 | 0.101 |
| 0.27 | 0.126 | 0.270 | 0.125 | 0.271 | 0.113 |
| 0.4 | 0.142 | 0.395 | 0.142 | 0.397 | 0.127 |
| 0.58 | 0.157 | 0.576 | 0.158 | 0.581 | 0.141 |
| 0.85 | 0.165 | 0.845 | 0.167 | 0.851 | 0.150 |
| 1.25 | 0.164 | 1.242 | 0.168 | 1.252 | 0.151 |
| 1.85 | 0.154 | 1.835 | 0.158 | 1.845 | 0.143 |
| 2.03 | 0.150 | 2.179 | 0.150 | 2.262 | 0.135 |

As can be seen, Example 2 of the invention maintains its significantly lower Tan Delta over the strain (DSA) range at a temperature in the region of high-speed tyre operating temperature and can therefore be expected to have a significantly lower rolling resistance over a range of loadings.

The values of elastic modulus E′ measured during the DMA tests with sweeping strain are set out in Table 4, together the elastic modulus as a percentage of elastic modulus at minimum strain.

TABLE 4
DMA Strain sweep at 70 Celsius

| | | |
|---|---|---|
| DSA (%) | E′ (MPa) | E′/E′o |

Conventional

| | | |
|---|---|---|
| 0.04 | 16.15 | 100% |
| 0.06 | 16.12 | 100% |
| 0.09 | 16.01 | 99% |
| 0.13 | 15.69 | 97% |
| 0.19 | 15.16 | 94% |
| 0.27 | 14.38 | 89% |
| 0.40 | 13.42 | 83% |
| 0.58 | 12.41 | 77% |
| 0.85 | 11.45 | 71% |
| 1.25 | 10.63 | 66% |
| 1.85 | 10.02 | 62% |
| 2.03 | 9.90 | 61% |

Example 1

| | | |
|---|---|---|
| 0.04 | 15.88 | 100% |
| 0.06 | 15.84 | 100% |
| 0.09 | 15.69 | 99% |
| 0.13 | 15.34 | 97% |
| 0.19 | 14.75 | 93% |
| 0.27 | 13.92 | 88% |
| 0.40 | 12.93 | 81% |
| 0.58 | 11.88 | 75% |
| 0.85 | 10.89 | 69% |
| 1.24 | 10.03 | 63% |
| 1.84 | 9.36 | 59% |
| 2.18 | 9.17 | 58% |

Example 2

| | | |
|---|---|---|
| 0.04 | 14.21 | 100% |
| 0.06 | 14.20 | 100% |
| 0.09 | 14.08 | 99% |
| 0.13 | 13.79 | 97% |
| 0.19 | 13.35 | 94% |
| 0.27 | 12.69 | 89% |
| 0.40 | 11.91 | 84% |
| 0.58 | 11.06 | 78% |
| 0.85 | 10.23 | 72% |
| 1.25 | 9.52 | 67% |
| 1.85 | 8.96 | 63% |
| 2.26 | 8.75 | 62% |

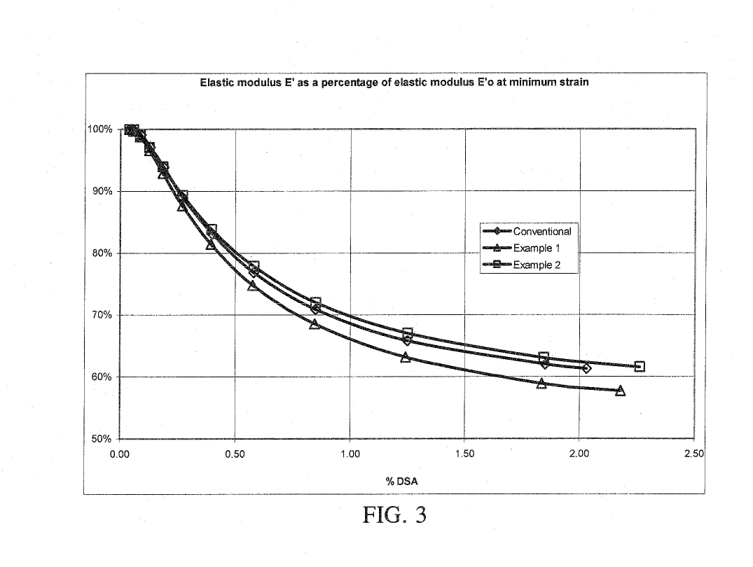

The elastic modulus E′ as a percentage of elastic modulus E′o at minimum strain is also shown in FIG. 3, from which it can be seen that all three compounds, and especially the Conventional Example and Example 2 of the invention, exhibit a similar strain dependency with respect to elastic modulus. This indicates the level of silanisation may be similar in each case and that addition of the alumino silicate microspheres has not compromised the silanisation reaction of the Conventional Example.

It will be appreciated that many modifications and developments may be made to the examples of the invention described above. For example, silanol groups on the surface of alumino silicate microspheres can retard the sulphur curing process, and it may therefore be advisable to use 3 to 5 phr of polyethylene glycol in a formulation containing this filler if silane coupling agents are not being used. Also, more strongly basic accelerators such as diphenyl guanidine (DPG) can be used to help counter the retardation effect.

It as also been found that when the alumino silicate microspheres are used as a filler with an polyisobutylene or similar hinder in the production of butyl rubber, the resultant product maintains a low permeability to air, making such butyl rubber particularly suitable for use as an inner liner for a vehicle tyre and in the manufacture of inner tubes for vehicle tyres.

Test have been carried out to compare compositions formulated in accordance with the Exxon bromobutyl standard formulation with Examples 3 and 4 of the invention in which the carbon black content of the composition has been partially replaced with Rocktron Mintron 7 alumino silicate spheres and in which the total proportion of filler has been increased. It should be noted that the binder of the bromobutyl standard formulation is an elastomeric isobutylene-isoprene copolymer containing reactive bromine. Because bromobutyl has the predominately saturated polyisobutylene backbone of butyl rubber, it has many of the attributes of the butyl polymer molecule.

The components of the tyre liner compositions of the conventional example and Examples 3 and 4 of the invention are set out in Table 5 below,

TABLE 5
Tyre liner compositions of Conventional
example and Examples 3 and 4

| Conven- | Example | Example |
|---|---|---|
| tional | 3 | 4 |

| | |
|---|---|
| Component | Weight (% weight) |

Binder

| | | | |
|---|---|---|---|
| Exxon Bromobutyl | 100.0 | 100.0 | 100.0 |
| | 54.3% | 51.2% | 48.5% |

Filler

| | | | |
|---|---|---|---|
| Carbon black N660 | 60.0 | 55.0 | 50.0 |
| | 32.6% | 28.2% | 24.2% |
| Alumino silicate microspheres | 0.0 | 16.0 | 32.0 |
| from pulverised fly ash. 7 μm | 0.0% | 8.2% | 15.5% |

Other

| | | | |
|---|---|---|---|
| Naphthenic oil | 8.0 | 8.0 | 8.0 |
| | 4.3% | 4.1% | 3.9% |
| Aromatic & aliphatic hydrocarbon | 7.0 | 7.0 | 7.0 |
| resin blend | 3.8% | 3.6% | 3.4% |
| Phenolic tackifying resin | 4.0 | 4.0 | 4.0 |
| | 2.2% | 2.0% | 1.9% |
| Magnesium oxide | 0.2 | 0.2 | 0.2 |
| | 0.1% | 0.1% | 0.1% |
| Stearic acid | 2.0 | 2.0 | 2.0 |
| | 1.1% | 1.0% | 1.0% |
| Zinc oxide | 1.0 | 1.0 | 1.0 |
| | 0.5% | 0.5% | 0.5% |
| Sulphur | 0.5 | 0.5 | 0.5 |
| | 0.3% | 0.3% | 0.2% |
| Mercaptobenzothiazyl disulfide | 1.5 | 1.5 | 1.5 |
| (MBTS) | 0.8% | 0.8% | 0.7% |
| Total | 184.2 | 195.2 | 206.2 |
| | (100%) | (100%) | (100%) |

It will also be noted that, in the Conventional example, the carbon black filler constituted about 33% by weight of the total composition. With Example 3 of the invention, 5 phr of the carbon black was replaced by 16 phr of the alumino silicate microspheres so that the alumino silicate microspheres constituted about 23% by weight of the filler, and the filler constituted about 36% by weight of the total composition. With Example 4 of the invention, 10 phr of the carbon black was replaced by 32 phr of the alumino silicate microspheres so that the alumino silicate microspheres constituted about 39% by weight of the filler, and the filler constituted about 40% by weight of the total composition.

Tests in accordance with ISO 2782 for air impermeability at 23° C. and 60 psi (about 410 kPa) showed that Examples 3 and 4 were similar to or better than the Conventional Example with regard to air impermeability.

Test also showed that Examples 3 and 4 had similar properties to the Conventional Example with regard to moving die rheometer (MDR) times, Mooney viscosity at T5 and T10, scorch times, Shore hardness, M100 stress, elongation at break and Dunlop resilience.

It will therefore be noted that Examples 3 and 4 are bulked out with the relatively inexpensive PFA-derived alumino silicate microspheres and include a lesser proportion of carbon black that the Conventional example, and yet the important properties of the materials are substantially unaffected.

The example compositions of the invention may be used in the formation of treads and inner liners on tyres and in the manufacture of tyre inner tubes in the conventional manner.

It should be noted that the examples of the invention has been described above purely by way of example and that many modifications and developments may be made thereto within the scope of the present invention.

1. A composition for a tread, inner liner or inner tube for a vehicle tyre, the composition including a natural or synthetic rubber binder and a filler, the filler including alumino silicate microspheres formed from pulverised fly ash.

2. A composition as claimed in claim 1, wherein the alumino silicate microspheres have a median diameter at least 1 micron.

3. A composition as claimed in claim 1, wherein the alumino silicate microspheres have a median diameter at least 4 microns.

4. A composition as claimed in claim 1, wherein the alumino silicate microspheres have a median diameter of no more than 50 microns.

5. A composition as claimed in claim 1, wherein the alumino silicate microspheres have a median diameter of no more than 20 microns.

6. A composition as claimed in claim 1, wherein the alumino silicate microspheres constitute at least 8% by weight of the total filler.

7. A composition as claimed in claim 1, wherein the alumino silicate microspheres constitute at least 16% by weight of the total filler.

8. A composition as claimed in claim 1, wherein the alumino silicate microspheres constitute at least 30% by weight of the total filler.

9. A composition as claimed in claim 1, wherein the filler also includes at least one of silica and carbon black.

10. A composition as claimed in claim 1, wherein the binder includes styrene butadiene.

11. A composition as claimed in claim 1, wherein the binder includes polybutadiene.

12. A composition as claimed in claim 1, wherein the binder includes isobutylene.

13. A vehicle tyre having a tread formed from a composition including a natural or synthetic rubber binder and a filler, the filler including alumino silicate microspheres formed from pulverised fly ash.

14. A vehicle tyre as claimed in claim 13, wherein the alumino silicate microspheres have a median diameter lying in a range from 1 to 50 microns.

15. A vehicle tyre as claimed in claim 14, wherein the alumino silicate microspheres constitute at least 8% by weight of the total filler.

16. A vehicle tyre as claimed in claim 15, wherein the binder includes styrene butadiene.

17. A vehicle tyre having an inner liner formed from a composition including a natural or synthetic rubber binder and a filler, the filler including alumino silicate microspheres formed from pulverised fly ash.

18. A vehicle tyre as claimed in claim 17, wherein the alumino silicate microspheres have a median diameter lying in a range from 1 to 50 microns.

19. A vehicle tyre as claimed in claim 18, wherein the alumino silicate microspheres constitute at least 16% by weight of the total filler.

20. A vehicle tyre as claimed in claim 19, wherein the binder includes isobutylene.
